(19) United States
(12) Patent Application Publication
(10) Pub. No.: US 2003/0179475 A1
(43) Pub. Date: Sep. 25, 2003

(54) Motion mechanism

(76) Inventors: Stefans Frits Brouwer, Den Haag (NL); Paulus Geradus Maria Van Stiphout, Woerden (NL); Johannes Backer, Leiden (NL)

Correspondence Address: Eaton Corporation, Patent Law Department, Eaton Center, 1111 Superior Avenue, Cleveland, OH, 44114-2584, US

(21) Appl. No.: 10/297,973

(22) PCT Filed: Jun. 12, 2001
(86) PCT No.: PCT/NL01/00444

(30) Foreign Application Priority Data
Jun. 14, 2000 (NL) 1015428

(51) Int. Cl. G02B 7/182

(52) U.S. Cl. 359/871

(57) ABSTRACT

A motion mechanism comprises a substantially spherically curved holder, a substantially spherically curved bowl and a substantially spherically curved support element. The holder, bowl and support element, when inserted into eachpother in this order, are rotatable relative to each other about a first axis, the X-axis, and a second axis, the Y-axis. The axes lie in a plane substantially coinciding with the plane of the outer edge of the holder or extending parallel thereto. The holder is connected to the support element for rotation about the Y-axis and the support element together with the holder are connected to the bowl for rotation about the X-axis. The drive means for moving the holder about said axes can substantially be arranged in the holder itself.

The present invention relates to a motion mechanism, comprising a substantially spherically curved holder, a substantially spherically curved bowl and a substantially spherically curved support element, which holder, bowl and support element, when inserted into each other in this order, are rotatable relative to each other about a first axis, the X-axis, and a second axis, the Y-axis, which axes lie in a plane substantially coinciding with the plane of the outer edge of the holder or extending parallel thereto.

Such motion mechanism can, for instance, be used for causing an object which is fixedly connected to the holder to make a movement about two axes, relative to a fixedly arranged structural part, and can be used for, for instance, wing mirrors of vehicles, in which a mirror plate can be mounted on the holder, while said structural part is mounted in the housing of the mirror plate, which housing can be fixed on a vehicle.

A motion mechanism as described in the preamble is known from EP-A-0 075 259. The motion mechanism is used therein in particular for rearview mirrors in vehicles, said structural part being formed by the support element which is fixedly connected to the vehicle, while the bowl is connected to the support element for rotation herein about a first axis and the holder is in turn connected to the bowl for rotation about a second axis. Here, the entire unit forms a ball hinge. Mounted on the holder of the ball hinge is a mirror which can be adjusted about the two axes by means of motors. It has been found that such construction does not meet the requirements that are currently imposed on adjustable mirrors for vehicles; in particular, a compact construction of the mirror housing is rendered difficult.

The object of the invention is to provide a motion mechanism which enables in an accurate and, in terms of production, advantageous manner, a relative movement of a substantially spherically curved holder relative to a substantially spherically curved structural part, to be fixedly arranged, about two axes, while by means of such motion mechanism, there can also be obtained an extremely compact construction of the mirror adjusting means to be accommodated in the mirror housing.

To that end, according to the invention, the motion mechanism as described in the preamble is characterized in that the holder is connected to the support element for rotation about the Y-axis and the support element together with the holder are connected to the bowl for rotation about the X-axis, while the drive means for moving the holder about said axes can substantially be arranged in the holder itself. In EP-A-0 075 259, the space within the holder is minimal to such an extent that it only provides room for the fastening element for holding together the holder, the bowl and the support element.

To ensure the connection between the holder and the support element, the holder comprises a flange-shaped edge with engagement means, while the support element likewise comprises engagement means, by means of which two engagement means these elements can engage each other while they are rotatable about the Y-axis.

For the connection between the holder and the support element on the one hand and the bowl on the other, the bowl is retained between the holder and the support element, while locking means are present to prevent a movement of the support element relative to the bowl about the X-axis. Such locking means could also be arranged between the holder and the bowl.

The support element is in particular formed from steel, while the holder and the bowl can be manufactured from plastic.

In a first embodiment, the support element is formed by a spherically curved, flattened ring, while in a second embodiment, the support element is formed by a spherically curved strip. To both embodiments, its applies that to be able to take up vibrations in the motion mechanism, this support element can be of springing design; in particular, to that end, it has a part which is bent outwards in the direction of the bowl and by which it presses against the bowl.

Because the “fixedly” arranged structural part is here formed by the bowl, it is favorable when it is provided with fasteners for fixing it on a frame relative to which the holder is movable in both axis directions. The support element together with the holder can then move about the X-axis relative to the bowl and hence also relative to the frame, while the holder can move about the Y-axis relative to the support element and move, due to the presence of the locking means, relative to the bowl and hence also relative to the frame. During movement about the X-axis, in the second embodiment, the support element moves through the outwardly bent part provided therein in the longitudinal direction over the outer surface of the bowl.

When used in a wing mirror of a vehicle, an adjusting plate with a mirror can be fixed on the holder. The mirror can then be moved manually about the X-axis and the Y-axis.

However, a major advantage of the motion mechanism according to the invention resides in the fact that drive means for motor-driven movement of the holder about the X-axis and the Y-axis can be accommodated in the holder itself. For this purpose, according to a further aspect of the invention, the holder is provided with two mutually perpendicular slots, viewed in the X-Y plane, through the holder, while in each slot an adjusting element is provided so as to be motor-displaceable, which adjusting element is further freely movable in the bowl in a direction, viewed in the X-Y plane, perpendicular to that of a relevant slot in the holder, while further, the adjusting element engages, through the relevant slot in the holder, a drive mechanism arranged in the holder, which drive mechanism is connected to a motor that is likewise arranged in the holder.

When the motor and the drive mechanism are arranged in the holder as well, the holder with the components arranged and fixed therein can subsequently be introduced into the bowl as a unit, whereafter this whole assembly can be snapped fixed in the support element.

The invention does not only relate to a motion mechanism, but also to a wing mirror unit for a vehicle, comprising a motion mechanism for a mirror as referred to hereinabove.

The invention will now be specified with reference to the accompanying drawing. In this drawing:

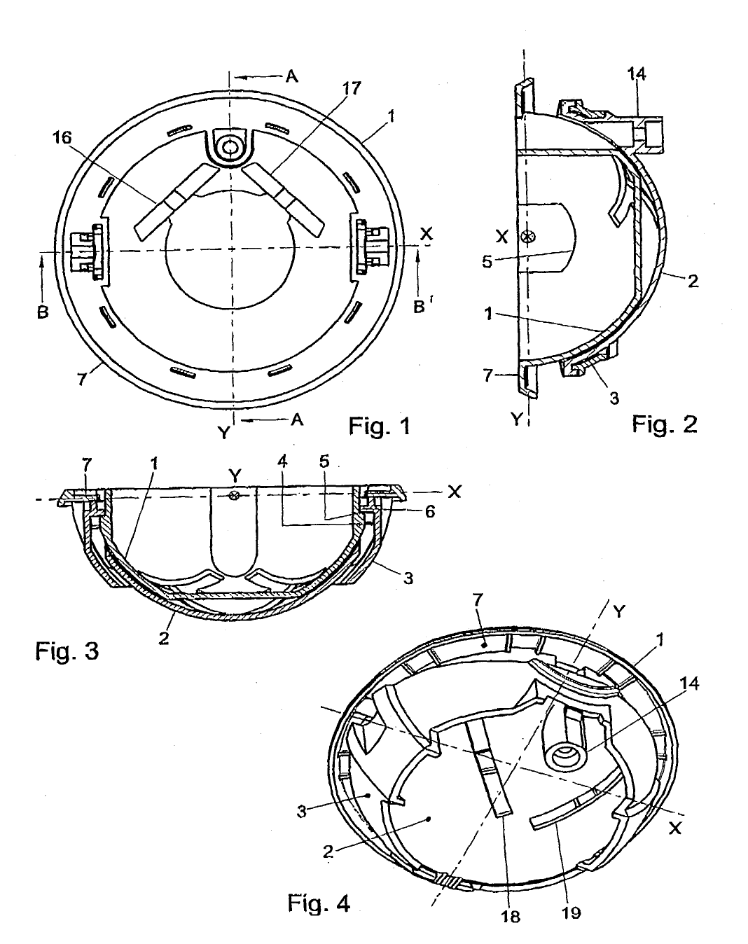

FIG. 1 is a top plan view of the motion mechanism in a first embodiment according to the invention;

FIG. 2 shows a section taken on the line A-A of the motion mechanism in FIG. 1;

FIG. 3 shows a section taken on the line B-B of the motion mechanism in FIG. 1;

FIG. 4 is a perspective view of the motion mechanism shown in FIGS. 1-3;

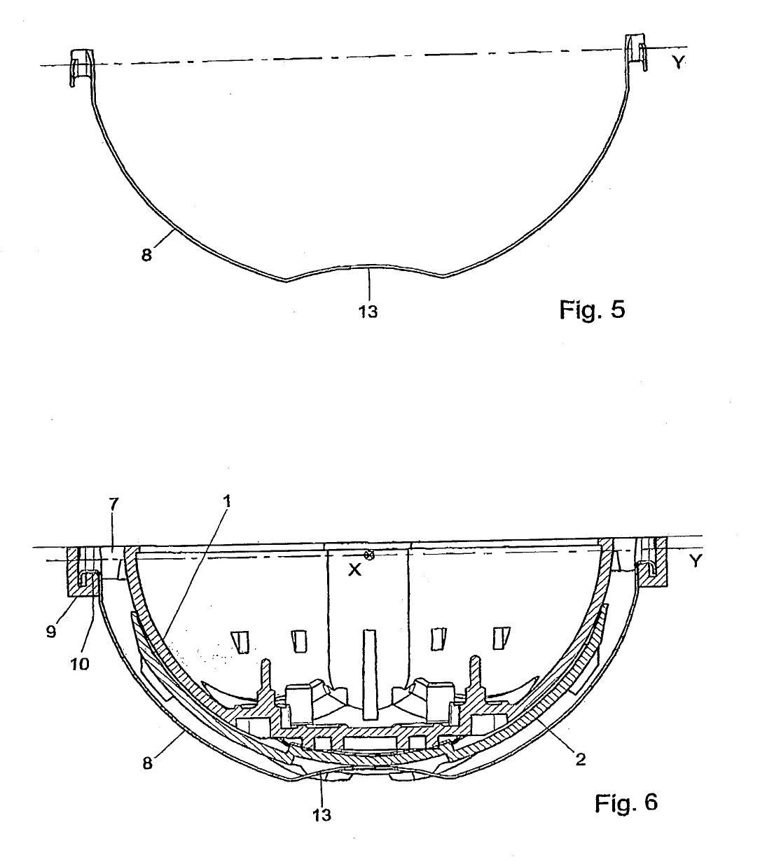

FIG. 5 is a side elevation of a support element for the motion mechanism in a second embodiment according to the invention;

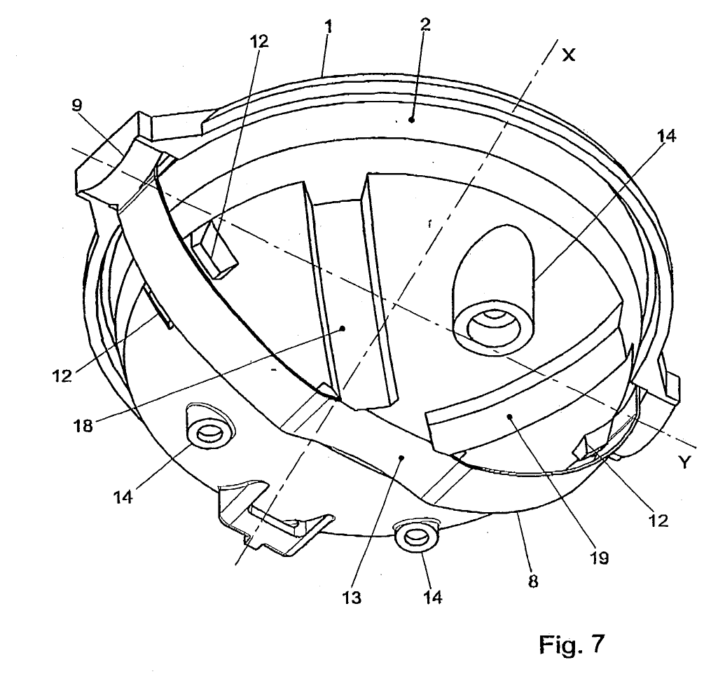

FIG. 6 shows a section of the motion mechanism in this second embodiment;

FIG. 7 is a perspective view, viewed from the outside of the motion mechanism in FIG. 6; and

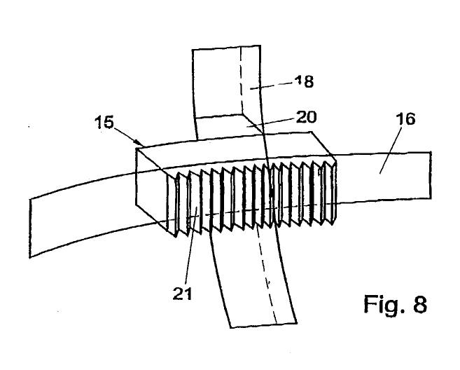

FIG. 8 shows an adjusting element for enabling rotation of the holder and the bowl relative to each other.

In the Figures, identical parts are designated by identical reference numerals.

A first exemplary embodiment of the motion mechanism according to the invention is shown in FIGS. 1-4 and comprises a substantially spherically curved holder 1, a substantially spherically curved bowl 2 and a support element in the form of a substantially spherically curved, flattened ring 3. The holder 1 and the bowl 2 are manufactured from plastic, while the ring 3 is manufactured from steel. The holder 1 is connected to the ring 3 for rotation about the Y-axis, while the ring 3 together with the holder 1 are connected to the bowl 2 for rotation about the X-axis. The bowl 2 can be fixedly connected to a frame or housing relative to which the holder 1 can move about the X-axis and the Y-axis. The X-axis and the Y-axis lie in a plane substantially coinciding with the outer edge of the holder 1.

For realizing the rotatability of the holder 1 relative to the ring 3, thickenings 4 have been provided diametrically relative to each other on the outer side of the holder 1, which thickenings 4 have a circularly curved edge 5, and gripping edge pieces 6 are present on the ring 3 which are diametrical relative to each other and directed inwards, which gripping edge pieces, when the holder 1 and the ring 3 are pressed one into the other, snap around the circularly curved edge 5. Viewed in a section perpendicular to the X-axis and as is shown in FIG. 4, the ring 3 is segment-shaped with an apex angle smaller than 180°. By this, and by the top edge of the holder 1, the possibility of rotation of the holder 1 relative to the ring 3 is limited.

Between the holder 1 and the ring 3, the bowl 2 is retained. The bowl 2 would be freely rotatable in all directions between these two elements, were it not that locking means (not shown in the Figures of this embodiment) are present between the bowl 2 and the ring 3 for preventing a rotation of the ring 3 about the Y-axis relative to the bowl 2.

The holder 1 has its top side provided with a flange-shaped edge 7 to which an object to be moved can be attached.

In the second embodiment shown in FIGS. 6 and 7, the holder 1 and the bowl 2 are designed in a substantially identical manner, yet the support element is formed by a substantially spherically curved strip 8. To realize the rotatability of the holder 1 relative to the strip 8, hook-shaped, inwardly directed engagement parts 9 having a circularly curved inner edge 10 have been provided, diametrically relative to each other, at the bottom side of the edge 7, and the ends of the strip 8 are provided with bent-over ends having correspondingly circularly curved engagement parts 11, which engagement parts 9 and 11, when the holder 1 with bowl 2 is pressed into the strip 8, engage around the relevant inner edges 10. The limiting of the rotation of the holder 1 relative to the strip 8 is determined by the dimensioning of the engagement parts 9 and 11.

At the outer side of the bowl 2, locking means 12 are present in the form of projections, to prevent a rotation of the strip 8 relative to the bowl 2. By giving the strip a bent-through shape in the central portion 13, directed towards the bowl 2, and by designing the strip from spring steel, an additional force is exerted on the bowl 2 and the whole assembly of holder, bowl and strip is pressed together so as to be free from vibration.

The bowl 2 can be provided with mounting bushes 14. By means of screws passed through these bushes, the bowl can be secured in a frame or housing, such as, for instance, the mirror frame housing for a wing mirror of a vehicle. When in this utilization, a mirror adjusting plate with mirror is fixed on the holder 1, in particular, as indicated hereinabove, on the edge 7 thereof, the holder with strip and, accordingly, the mirror is manually rotatable about the X-axis relative to the bowl and hence relative to the mirror frame housing; this involves the strip moving over the bowl while being pressed against the bowl with spring action. The locking of the bowl 2 relative to the strip 8 in respect of movements about the Y-axis enables a manual movement of the holder 1 relative to the strip 3 in any position adopted by the holder 1 relative to the bowl 2.

In both embodiments shown, the motion mechanism is suitable for being driven by a motor, while the drive means can be accommodated in the holder 1. In a manner usual for mirror actuators, for the rotation about each of the two axes (the X-axis and the Y-axis), the drive means, not further shown in the Figures, comprise a motor in a housing and a transmission mechanism. These components form in fact the actuator. Although a rod-shaped transmission may be included in the transmission mechanism, in view of the limited space in the holder, it is favorable when the transmission is designed as gear transmission. By means of this transmission, an adjusting element 15 is displaced in a first direction, while this adjusting element 15 is freely movable in a second direction perpendicular to the first direction. To enable in this manner a rotation of the holder 1 relative to the bowl 2, two slots 16 and 17 are provided in the holder 1, which slots are perpendicular to each other viewed in the X-Y plane, while in the bowl 2, two slots 18 and 19 are provided, which slots are perpendicular to each other viewed in the X-Y plane, the slot 16 intersecting the slot 18 perpendicularly at midpoint and the slot 17 intersecting the slot 19 perpendicularly at midpoint. The slots 18 and 19 in the bowl 2 extend from the circumferential edge to the center of the bowl. To each pair of slots 16, 18 and 17, 19, it applies that an adjusting element 15 is freely movable in the slot 18, 19 respectively, and motor-drivable in the slot 16, 17 respectively. However, the reverse is of course also possible, i.e. an adjusting element may also be freely movable in the slot 16 and/or 17 and motor-drivable in the slot 18, 19 respectively. Although the adjusting elements 15 are provided between the holder 1 and the bowl 2, the adjusting elements project through the holder 1 for motor-engagement from the inner space of the holder 1. One of the two adjusting elements 15 is shown in more detail in FIG. 8. The free movability of the adjusting elements 15 is realized in that on the bowl-facing side, they are provided with a projection 20 engaging the slots 18 and 19. On the side of the adjusting elements 15 projecting through the holder, they are provided with teeth 21. In the Figure, the adjusting elements are designed as ring segments having internal teeth; of course, an embodiment as ring segment having, for instance, crown teeth or conical gear teeth is also possible. These teeth then cooperate with a correspondingly shaped gear of the gear transmission mechanism.

The direction in which the adjusting elements 15 are motor-drivable may correspond to the two axis directions. However, if stepping motors are used instead of standard DC-motors, it is preferred that the adjusting elements be displaced by motor at an angle of 45° relative to the two axis directions; this situation applies to the embodiments shown here. Accordingly, during a rotation about one of the axes, both motors are actuated. Through the motor displacement of one or both adjusting elements and the free movability in directions perpendicular hereto, a rotation of the holder 1 relative to the bowl 2 is effected and, accordingly, when used in a wing mirror of a vehicle, a rotation of the mirror adjusting plate with mirror is effected relative to the mirror housing in which the mirror housing frame with bowl are fixedly accommodated.

During assembly, the holder with accessories can be assembled as a separate unit; hence, this unit comprises the holder 1 including the motors and the transmission mechanism and the mirror adjusting plate 33 with mirror 34. After the bowl 2 is fixed on a frame or housing, the strip 8 can be passed underneath the bowl 2 and snapped onto the holder with accessories inserted into the bowl. If the ring 3 is used, it is held around the bowl, while the bowl is fixed onto said housing or frame.

The invention is not limited to the embodiments here described with reference to the Figures, but comprises all kinds of modifications hereof, of course in so far as these fall within the protective scope of the following claims. The use is neither limited to wing mirrors for vehicles; the motion mechanism can be used for all kinds of applications where an object should be capable of moving relative to a frame or housing about two axes.

1. A motion mechanism, comprising a substantially spherically curved holder, a substantially spherically curved bowl and a substantially spherically curved support element, said holder, bowl and support element, when inserted into each other in this order, being rotatable relative to each other about a first axis, the X-axis, and a second axis, the Y-axis, said axes lying in a plane substantially coinciding with the plane of the outer edge of the holder or extending parallel thereto, characterized in that the holder is connected to the support element for rotation about the Y-axis and the support element together with the holder are connected to the bowl for rotation about the X-axis, while the drive means for moving the holder about said axes can substantially be arranged in the holder itself.

2. A motion mechanism according to claim 1, characterized in that the holder comprises a flange-shaped edge having engagement means, while the support element likewise comprises engagement means, by means of which two engagement means said elements can engage each other while they are rotatable about the Y-axis.

3. A motion mechanism according to claim 1 or 2, characterized in that the bowl is retained between the holder and the support element, while locking means are present to prevent a movement of the support element relative to the bowl about the Y-axis.

4. A motion mechanism according to any one of the preceding claims, characterized in that the support element is made of steel, and the holder and the bowl are made of plastic.

5. A motion mechanism according to any one of the preceding claims, characterized in that the support element is formed by a spherically curved, flattened ring.

6. A motion mechanism according to any one of the preceding claims, characterized in that the support element is formed by a spherically curved strip.

7. A motion mechanism according to claim 6, characterized in that the support element is of spring design.

8. A motion mechanism according to any one of the preceding claims, characterized in that the support mechanism has a part bent outwards in the direction of the bowl, whereby the support mechanism presses against the bowl with spring action.

9. A motion mechanism according to any one of the preceding claims, characterized in that the bowl comprises fasteners for fixing it to a frame relative to which the holder is movable in both axis directions.

10. A motion mechanism according to any one of the preceding claims, characterized in that the holder is provided with two mutually perpendicular slots through the holder, viewed in the X-Y plane, each slot having an adjusting element provided therein for motor displacement, said adjusting element further being freely movable in the bowl in a direction, viewed in the X-Y plane, perpendicular to the direction of a relevant slot in the holder, while further, the adjusting element engages, through the relevant slot in the holder, a drive mechanism arranged in the holder, said drive mechanism being connected to a motor which is likewise arranged in the holder.

11. A motion mechanism according to claim 10, characterized in that on the holder, an adjusting plate for, for instance, a mirror is secured, and that the holder with the components arranged therein and secured thereto can be introduced into the bowl as a unit, after which this whole assembly can be fixed in the support element by snapping.

12. A wing mirror unit for a vehicle, comprising a motion mechanism for a mirror according to any one of the preceding claims.
